(19) United States
(12) Patent Application Publication
(10) Pub. No.: US 2025/0087026 A1
(43) Pub. Date: Mar. 13, 2025

(54) Facial Recognition System and Method that Utilizes Multimodal Biometrics Obtained by a Single Camera

(71) Applicant: Personavera, LLC, Langhorne, PA (US)

(72) Inventors: Michael Braithwaite, Langhorne, PA (US); Randal Glass, Cherry Hill, NJ (US)

(21) Appl. No.: 18/817,060

(22) Filed: Aug. 27, 2024

Related U.S. Application Data
(60) Provisional application No. 63/581,452, filed on Sep. 8, 2023.

(51) Int. Cl. G06V 40/70; G06V 10/14; G06V 40/16; G06V 40/18

(52) U.S. Cl. CPC G06V 40/70; G06V 10/14; G06V 40/171; G06V 40/172; G06V 40/193; G06V 40/197

(57) ABSTRACT

A system and method of identifying a person using multimodal biometrics. A camera assembly is provided having a single imaging camera and a specialized imaging lens. The camera assembly produces an image having a first central area and a second outer area. The first central area has a first focal length. The second outer area has a second smaller focal length. As a result, the imaging lens produces a first level of distortion in the first central area and a different second level of distortion in the second outer layer. The first level of distortion includes magnification of features in the first central area of the image. The camera assembly is used to image a face having eyes and facial features. The eyes are imaged in the first central area of the image. At least some of the facial features are imaged in the second outer area of the image. The iris pattern data and the facial features data are compared to at least one identification database to find matches.

### BACKGROUND OF THE INVENTION

### 1. Field of the Invention

The present invention relates to identification systems that attempt to identify a person using data collected from an imaging camera. More particularly, the present invention relates to identification systems that use data regarding both iris patterns and face geometry to identify a person.

### 2. Prior Art Description

There are many scenarios in which the identity of a person must be verified. Often, such verification is accomplished using a biometric scan, such as a face recognition scan or an iris pattern scan. However, many existing systems have high False Acceptance Rates (FAR) that limit the usefulness of such systems. In the field of biometric scanning, certain applications require a performance level of FAR<1E⁻²⁰ for global, errorless identification. Importantly, errorless identification enables absolute de-duplication of records, which is an essential attribute for fraud-proofing every person's identity within the identity authentication system. Prevention of duplication ensures against all others scheming to masquerade their own identity to fraudulently substitute themselves for accessing the benefits of others. This extraordinary level of ID accuracy is orders of magnitude greater than that achieved by typical DNA laboratory test results, which are typically less than one error in 100 trillion bits matched. Ensuring biometric FAR<1E⁻²⁰ requires less than 1 error in 100 million-trillion bits matched. Furthermore, setting the minimum threshold for the least score to pass at FAR<1E⁻²⁰ forces a shift to the mean of the universal population distribution to approximately FAR<1E⁻⁵⁰. Therefore, the average score must perform to less than one error over one-with-fifty zeros of matched bits. The only reliable way to achieve this level of a false acceptance rate is to scan, analyze and combine multiple biometrics on the same person. This is known as multimodal biometrics in the industry.

For example, a fusion-score of facial features and two eye irises has the combined potential at maximum Fusion Biometric Entropy (FBE) to achieve theoretical FAR=1E⁻¹⁷². The breakdown for each iris contributes a maximum FBE potential of 1E⁻⁷⁸. Accordingly the scan of two irises doubles the exponent to 1E⁻¹⁵⁶. The scan of facial features produces an FBE potential of 1E⁻¹⁶. The sum total FBE of all three scans is FAR=1E⁻¹⁷².

Biometric performance has been studied and documented by the U.S. National Institute of Standards (NIST). NIST publicly shares data, test results and analysis via their websites including Iris Exchange (IREX) and Face Recognition Vendor Test (FRVT). Information by others including academics along with NIST biometric test results provide highly reliable and accurate performance metrics for large-scale populations exceeding one billion. However, in order for the identification system to be accurate, usable images must be available. NIST has tested, analyzed, and published the performance and rankings of iris algorithms by quantifying both the False Match Rate (FMR) and the False Non-Match Rate (FNMR) relationships, which are associated to algorithm-level induced errors from an existing gallery of captured iris images. Failure Analysis that describe sub-categories of catastrophically failed iris images often fail to progress to the matching process step because they have either failed to crop, segment and/or encode into an iris template. Overall, NIST reported 1.4% of images were classified into a catastrophically non-matching type with the balance (98.6%) succeeding to match with an associated performance FAR score. The principal label of the non-matching failure categories are referred to as either Failure to Capture or Failure to Acquire (FtC or FtAR).

The US Department of Homeland Security (DHS) has conducted performance testing of selected state-of-the-art biometric systems to determine the full end-to-end performance levels specifically including FtC/FtARs errors. The 2019 Biometric Rally published report of the DHS concluded the performance of all tested iris acquisition (ACQ) systems were unacceptable because the FtAR failures exceeded their ≤5% performance goal within 5 or 20 seconds of image acquisition. The FtAR results of the tested iris ACQ systems ranged from ≥12% to ≥95% depending upon the timeout setting of 5 and 20 seconds. In contrast, NIST reported only 1.4% FNMR for iris problem images. The comparative difference in two outcomes confirms that the algorithm-level reject errors (FNMR) are a relatively minor contributor to the complete error set quantified by the False Reject Rate (FRR) metric that includes the FtAR rate.

The iris is the colored portion of the eye that surrounds the pupil. The iris is not a single monochromatic color. Rather, the iris has a complex pattern of overlapping colors, lines, and speckles that extend throughout the iris. Since the iris pattern of an individual is such a good biometric identifier, there have been many prior art systems developed to image the iris of an individual and use that image for identification purposes. Such prior art systems are exemplified by U.S. Pat. No. 5,291,560 to Daugman, entitled, Biometric Personal Identification System Based On Iris Analysis, U.S. Pat. No. 7,277,561 to Shin, entitled Iris Identification, and U.S. Pat. No. 7,796,784 to Kondo, entitled Personal Authentication Method For Certificating Iris. In all such prior art systems, a clear, high resolution image of the iris is required. Such a requirement can present a problem, in that obtaining a high quality image of a person's iris in the real world is very difficult. The iris can be occluded by the eyelids, hair, eyeglasses, or sunglasses. Even if not occluded, there is often too little ambient illumination available or specularities that prevent the capture of the full details of the irises in an image. This problem is amplified when only one camera is used and the one camera is not specifically focused at the eyes due to positional circumstances or the need to observe other features, such as the appearance of the face.

Collecting image data for facial features and the two iris patterns can be obtained using multiple cameras, i.e., one or two cameras for each iris and another dedicated camera for the face. The multi-camera solution enables each camera to have an optimal field of view and corresponding imaging qualities such as resolving power. However, the field of view for the camera imaging the face is optimized for facial biometrics and is much different from the field of view and resolution power needed for the irises. Accordingly, the coordinated use of multiple cameras can present performance problems, which are isolated by the FtAR metric.

A need therefore exists for an improved multimodal biometrics system that can identify a person using only a single imaging camera, yet provides an extremely high rate of accuracy in a manner that is time efficient, processor friendly, and is both economically and technically reasonable. This need is met by the present invention as described below.

### SUMMARY OF THE INVENTION

The present invention is a system and method of identifying a person using multimodal biometrics. A camera assembly is provided having a single imaging camera and a specialized imaging lens. The camera assembly produces an image having a first central area and a second outer area. The first central area has a first focal length. The second outer area has a second smaller focal length. As a result, the imaging lens produces a first level of distortion in the first central area and a different second level of distortion in the second outer layer. The first level of distortion includes magnification of features in the first central area of the image.

The camera assembly is used to image a face having eyes and facial features. The eyes are imaged in the first central area of the image. At least some of the facial features are imaged in the second outer area of the image.

Iris pattern data is obtained from the eyes imaged in the first central area of the image. Likewise, facial feature data is obtained from the facial features imaged, at least in part, from the second outer area of the image. The iris pattern data and the facial features data are compared to at least one identification database to find matches. If a match is found for both iris patterns and the facial features then the identification is considered errorless with a false acceptance rate far superior to DNA testing.

### BRIEF DESCRIPTION OF THE DRAWINGS

For a better understanding of the present invention, reference is made to the following description of exemplary embodiments thereof, considered in conjunction with the accompanying drawings, in which:

FIG. 1 shows an overview of an identification system imaging a person in the field of view of a camera assembly;

FIG. 2 shows a multimodal biometric data field superimposed over the image of a face;

FIG. 3 shows a system where a face is imaged with a foveal imaging lens to create enhanced multimodal biometric data;

FIG. 4 show a graph for an exemplary foveal objective lens that plots image height against distortion percentage and a working distance set at the infinite; and

FIG. 5 shows a block logic flow diagram outlining the method of operation for the present invention system.

### DETAILED DESCRIPTION OF THE DRAWINGS

Although the present invention identification system can be embodied in many ways, the present invention system is particularly well suited for miniature identification systems such as those used in point of sale systems, an Automated Teller Machine (ATM), or a web-cam like camera for personal on-line authentication. The exemplary embodiment is selected in order to set forth one of the best modes contemplated for the invention. The illustrated embodiment, however, is merely exemplary and should not be considered a limitation when interpreting the scope of the appended claims.

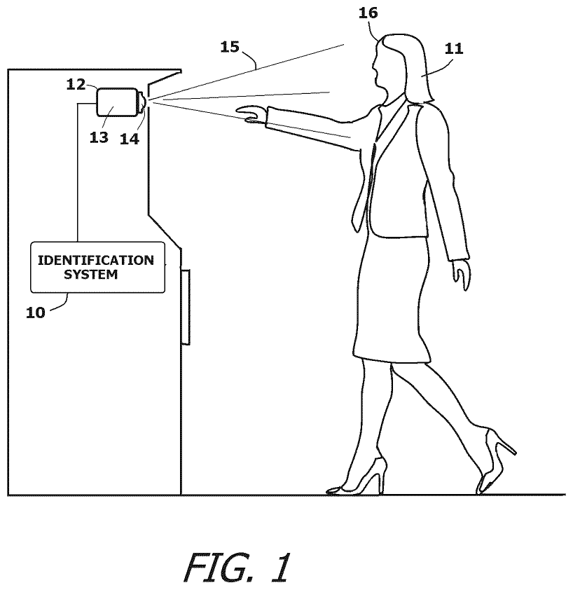

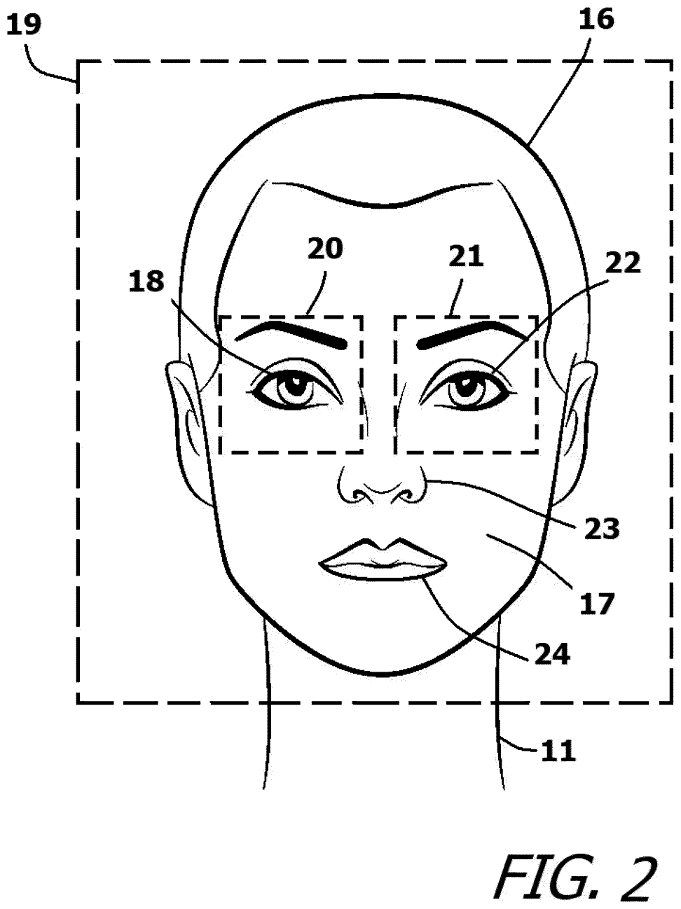

Referring to FIG. 1 in conjunction with FIG. 2, it will be understood that the present invention identification system 10 images and identifies a person 11 as that person 11 comes into range of a camera assembly 12. The camera assembly 12 includes an imaging camera 13 and a specialized imaging lens 14 that is later described in detail. The person 11 can stand in front of the camera assembly 12, such as when standing in front of a bank machine, a point-of-sale panel, or a personal computer. In all scenarios, a single imaging camera 13 is used. The camera assembly 12 has a field of view 15 sufficient to image the head 16 of the person 11 at a selected working distance. The head 16 is imaged in an attempt to capture both the facial features 17 and the iris patterns 18 of the person 11. Accordingly, the image collected by the camera assembly 12 must contain a large imaging field 19 that can encompass the overall facial features 17 of the person 11 and two smaller imaging fields 20, 21 for the eyes 22. The large imaging field 19 used to capture the facial features 17 must have enough area and detail to discern the shape of the face, and the positions of various points on and around the eyes 22, nose 23, and mouth 24. The imaging fields 20, 21 for the eyes 22 are smaller but must contain enough detail to map the iris patterns 18 in at least one of the eyes 22, and preferably both of the eyes 22. The resolution needed in the imaging fields 20, 21 for the eyes 22 is greater than that needed in the large imaging field 19 for the facial features 17. If done accurately, combined imaging fields 19, 20, 21 for the overall facial features 17 and two eyes 22, provides the three sets of biometric data needed to achieve the FAR<1E⁻²⁰ accuracy level required for the identification system 10.

The one camera assembly 12 is used to collect the three imaging fields 19, 20, 21, simultaneously. One camera can only have one field of view. It will therefore be understood that from an electro-optics design perspective, imaging of the facial features 17 versus the imaging of the iris patterns 18 have different field of view requirements. This creates a conflict with the optimal focal length settings for the imaging lens 14 used in the camera assembly 12. Facial features 17 in the large imaging field 19 require relatively low resolution that is optimized by a lower focal length lens with a wider field of view. Conversely, iris patterns 18 imaged in the smaller imaging fields 20, 21 require higher resolution by a higher focal length lens with a corresponding narrower field of view. These opposing requirements matter greatly in the design of the imaging lens 14. Imaging facial features 17 requires a large field of view 15, indicated by the large imaging field 19, to fully envelop all the facial features 17 of the person 11. Accordingly, a small focal length works best. Conversely, detecting the iris patterns 18 requires a small field of view, where a larger focal length lens works best. Compounding the severity of optical deviation design challenge to a far greater extent is the field of view accommodation of the standing variance of the head height of the people being imaged.

The identification of iris patterns 18 from an image requires a spatial frequency of greater than 15.7 pixels/mm and an optical modulation transfer function of greater than fifty percent at the plane of the iris. The modulation transfer function in object space is a constant value. However, successful capture of the iris patterns 18 must accommodate the range of distances between the imaging camera 13 and the person 11 being imaged. Therefore, the modulation transfer function constant value in object space must be translated to the modulation transfer function at the image plane by applying the following governing equations over a working distance (WD) and lens focal length values for the imaging lens 14.

$$Image space MTF is ( lp / mm ) = \frac{Object space MTF ( lp / mm )}{PMAG}$$

PMAG is Primary Magnification, where negative polarity means the image is inverted.

MTF is the modulation transfer function.

$$PMAG = - ( 1 / ( FL - 1 / WD ) ) / WD .$$

PMAG=sensor size (mm)/Field of View (mm), where

FL is the lens Focal Length (mm).

WD is Working Distance (mm) from the imaging lens to the object and,

lp denotes line-pair pitch/spacing of a black-and-white optical target.

It will be understood that for a camera and lens system to comply with the specified iris modulation transfer function equated at the image plane, the power of magnification must be increased in proportion with an increase in the working distance. As an example, to compute the modulation transfer function that results from an input of a twenty percent working distance, and a baseline starting working distance at 380 mm, the 2 lp/mm object space modulation transfer function equates to requiring image space modulation transfer function with a greater than fifty percent contrast at 74 lp/mm for a 10 mm lens. For the same 10 mm lens, increasing the working distance by twenty percent to 457 mm, causes the image space modulation transfer function lens performance requirement to increase to an 89.4 lp/mm requirement. The twenty percent longer working distance results in a twenty percent greater and more demanding lens resolving performance than its shorter working distance comparison point.

In order to achieve the same 2 lp/mm object space modulation transfer function at a working distance of 380 mm that increases twenty percent by increasing the working distance by twenty percent, the power of magnification must be proportionally increased by increasing the lens focal length by twenty percent. This example quantifies and links the same result amount to the same input change amount.

Likewise, but with a different example set contrasting both working distance cases at 380 mm, the 2 lp/mm object space modulation transfer function constant equates to requiring greater than a fifty percent contrast at 74 lp/mm for a 10 mm lens, or the less demanding image space modulation transfer function of 61.3 lp/mm for a 12 mm lens. Again, the same 20%/20% working distance input to focal length output change effect holds at two digits of accuracy. Twenty percent is merely a computed example to show the same focal change amount relates to the same image space modulation transfer effect. The one-to-one focal length-to-modulation transfer function effect approximation holds for different values.

These specific working distance, focal length, power of magnification and module transfer function results are generalized to a proportionally greater demand of the required lens modulation transfer function performance as the working distance increases. In short, for iris modulation transfer function compliance, increases in working distance WD causes a similar increase in the focal length of the imaging lens 14. Furthermore, lens designs have a diffraction limit attribute at a point where the lens resolving power becomes disrupted. The resolving capability of a lens, as expressed by the modulation transfer function, is hard stopped at the lens diffraction limit. Physics limits the performance of perfectly designed and manufactured optics to not exceed the diffraction limit that is related to the lens aperture by the well-defined Raleigh Criterion.

In the exemplary embodiment, the scan of the facial features 17 in the large image field 19 requires an interpupillary distance in the image of no less than 163 pixels. This equates to a spatial frequency that is greater than or equal to 1.6 pixel/mm, or ten percent compared to that required to scan the iris patterns 18 in the small imaging fields 20, 21. Imaging the facial features 17 has no stated optical modulation transfer function requirement. These specified iris pattern versus facial feature requirements are quantitively different in magnitude. Attempting to harmonize the differences into a single electro-optics design typically fails during the iris performance capture stage, producing unusable images.

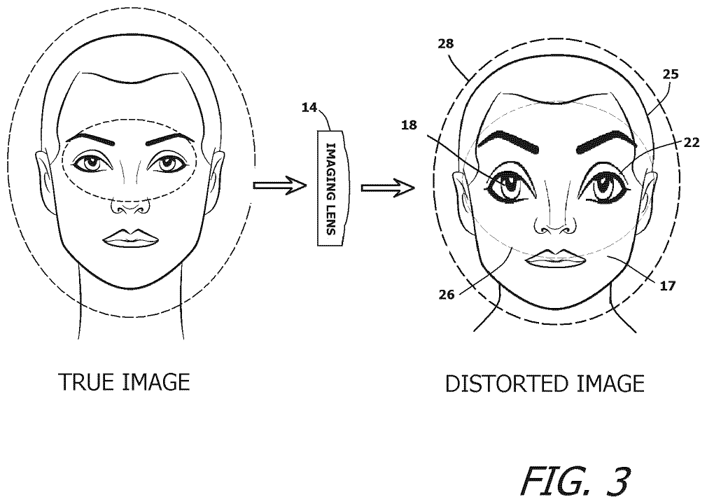

Referring to FIG. 3, in conjunction with FIG. 1 and FIG. 2, it can be seen that the problem is solved by providing the imaging lens 14 with a foveal lens design. The foveal lens design produces magnification distortions in the manner of a fisheye lens or a barrel distortion lens only in certain areas, therein producing a distorted image 25. In the preferred embodiment, the imaging lens 14 has lens curvatures that primarily distort the image in the central area 26 of the distorted image 25. The central area 26 is surrounded by an outer area 28 that equates to a lens with a smaller focal length and increased field of view. The result is a distorted image 25 with magnified optical effects in the central area 26. The central area 26 of the distorted image 25 includes the images of the eyes 22. Unlike the wide variety of available off-the-shelf lenses that a selection can suit most optical application attributes including both rectilinear and fisheye distortion types, the foveal design of the imaging lens 14 is atypical and includes unique descriptive nomenclature. The foveal design of the imaging lens 14 uses lens nomenclature that leverages the traditional focal length metric and expresses the two distortion extremes of the focal lengths. For example, a 9/11 imaging lens means the imaging lens 14 has a 9 mm focal length for the outer area 28 and an 11 mm focal length for the central area 26. A 9/11 foveal lens nomenclature is also meant to equate to an 11 mm focal length with negative 18% distortion. Although the imaging lens 14 is shown as a single lens, it should be understood that the imaging lens 14 can be an assembly of lens elements that work together to produce the foveal features described.

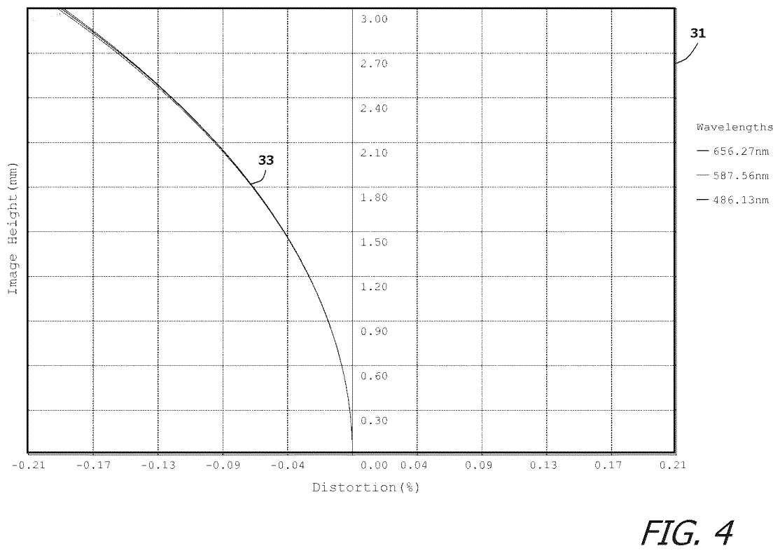

Referring to FIG. 4, a graph 31 for an exemplary foveal lens is shown that illustrates a change in distortion as a function of image height. The example distortion curve 33 shown is typical. This graph 30 illustrates that distortion is measured starting from the center of the lens and is cumulative outward toward the edges/corners. This typical curve shows distortion is numerically greatest in the outer areas.

Returning to FIG. 3 in conjunction with FIG. 1 and FIG. 2, it can be seen that the imaging lens 14 creates the distorted image 25. The distorted image 25 does not lose any information. The optical distortion merely dislocates information to a predictable location. The distortion is reversible and recoverable to near-zero residual effects by available digital image post processing techniques. The distortion recovery process that applies software correction to an optically distorted image in the opposite polarity is sometimes called warping or dewarping.

The iris patterns 18 are somewhat immune to lens distortion effects without imposing any warping or dewarping processes. As an example, a negative fifteen percent rectilinear, radial distortion of the full image frame that affects the iris circularity is reduced to negative one percent across the iris diameter because the iris is proportionally smaller than the full image frame of the whole face. A negative one percent distortion of the iris circularity causes a negligible match score impact. Therefore, optical magnification distortion, expressed as negative polarity, is a meaningful parameter for enabling multimodal biometric identification.

The optical distortion improves the ability to discern iris patterns 18 by presenting a distorted image 25 of superior contrast and quality. Distortion improves the resolution of particular digitized sectors of a wider field of view image without the need to increase the number of pixels per unit area of an image sensor or to provide a separate overlooking optical enlargement system. The distortion benefit actualizes the ideal iris pattern imaging shift to improved performance by optimized image quality attributes including improved spatial frequency and modulation transfer function to imaging locations where it matters most. This is done by creating greater magnification differentially toward the central area 28 of the distorted image 25 where most of the facial features 17 and the iris patterns 18 are located. Conversely, lesser magnification occurs toward the outer areas 28 of the captured image 25 where there is little or no useful imaging information. The primary spatial frequency and modulation transfer function effects of optical distortion are unity improvements of magnitude. For example, a negative fifteen percent optical distortion improves iris spatial frequency and modulation transfer function by a fifteen percent increase, which in turn contributes an amplified effect to the iris match score. Furthermore, there are also secondary spatial frequency and modulation transfer function benefits from the optical distortion. The modulation transfer function is typically not a constant across the image field as measured radially from center to edge. Typically, modulation transfer function is maximum at or near the image center and progressively reduces toward the image edges.

As compared to a conventional non-distorted lens, the foveal design of the imaging lens 14 improves the relative positioning of both eyes 22 toward the central area 26 away from the edges because the face is comparatively smaller and thus closer to the image center by the distortion effect. Therefore, the iris spatial frequency and the modulation transfer function are both secondarily improved by distortion where pixel density and modulation transfer function curves are toward the maximum image-center position.

Additionally, the imaging camera 13 with the specialized imaging lens 14 enables important supplementary benefits. The combination of the imaging camera 13 and the imaging lens 14 simplifies and improves the face-centric UI/UX by a single imaging device. The multifunctional capability completely avoids multi-camera complexities including parallax UI/UX design challenges. Another supplementary benefit of the foveal design of the imaging lens 14 is that it produces an enlarged field of view 15 that enhances horizontal, vertical, and depth range limits for UI/UX dynamic positioning feedback. For example, using a negative fifteen percent barrel-distortion optical value, the corresponding capture volume increases by approximately one third. Enlarging the simplified full-face UI/UX capture with the single imaging camera 13 amplifies biometric performance by reducing imaging errors.

The details of the foveal design for the imaging lens 14 depend upon use. There are at least three separate ergonomic categories, each with a different design for the imaging lens 14. The three most common applications include a point-of-sale (POS) or kiosk use. This includes an automatic teller machine where the person being imaged is close to the camera assembly 12. There is also a desktop use where the camera assembly 12 is typically mounted within a few feet of the person being imaged. Lastly, there is a passive immigration type setting that operates at a standoff distance and potentially has physical position restrictions. Examples of custom foveal designs for imaging lenses are delineated in the Table 1 below.

TABLE 1

| | Working | Height | Focal length |
|---|---|---|---|
| Category | Distance | variation | FL (mm) |
| POS/Kiosk | 12″~18″ | Standing | 9/11 |
| Desktop | 15″~26″ | Sitting | 10/12 |
| Immigration | 3 ft~6 ft | Standing | 35/40 |

The multimodal lens values listed within Table 1 accommodate large subject head dimensions and also accommodate standing height variances. In all cases the extent of preferred distortion measure exceeds the accepted practice of a rectilinear lens design that limits distortion to less than two percent for imaging/vision systems and even less for machine vision systems. It is preferred that the focal length of the outer area 28 be at least ten percent shorter than the focal length of the central area 26.

### Individual Biometric Entropy:

The iris patterns 18 are randomly formed by an epigenetic process (i.e., not DNA related) in the third trimester of development called chaotic morphogenesis, which is a random ripping of the iris tissues that remain stable throughout life. Each individual presents their own degree of biometric entropy, especially for iris patterns 18. The biometric entropy randomness for irises over a large population is Gaussian and is circumscribed by a bell-shaped curve. Therefore, about half of the population has naturally favorable biometric entropy associated with their irises while the other half tends towards lower than average. Because the average biometric entropy for the irises is well beyond what is required for successful errorless ID (FAR<1E⁻²⁰), then a high majority of individuals present ideal dual-iris patterns that can help to compensate for other performance-degrading factors, such as eyelid occlusion. Accordingly, a majority of the population present well for ideal image capture success with little or no need for repeated image capture attempts.

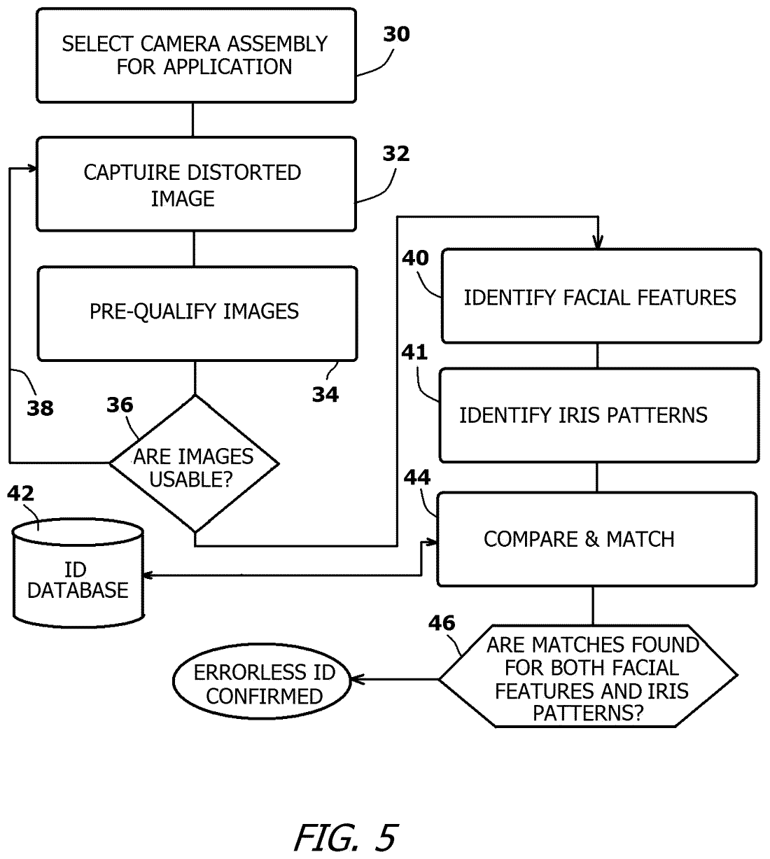

Referring to FIG. 5 in conjunction with FIG. 1, FIG. 2, and FIG. 3, it can be seen that the first step is to provide a camera assembly 12 with a single imaging camera 13 and the appropriate imaging lens 14. See Block 30. The selection of the imaging lens 14 depends upon the working distance between the imaging lens 14 and the person 11 to be imaged. The selection of the imaging lens 14 also depends upon the required field of view 15. The imaging lens 14 creates a distorted image 25 due to the foveal design of the imaging lens 14. Once the camera assembly 12 is selected, a person 11 is imaged as that person 11 come into the field of view 15. See Block 32.

Once a distorted image 25 is obtained, the distorted images 25 are pre-qualified. See Block 34. This is accomplished by scanning the enlarged imaging fields 20, 21 for the eyes 22. Multiple iris quality metrics are then dynamically applied to quickly evaluate and differentiate an ideal image from lesser quality images. The iris quality metrics processes operate faster than frame rate causing no adverse impact to the UI/UX because quality metric operations are essentially transparent. Distorted images 25 that are evaluated to be substandard or non-ideal for both irises are promptly rejected, and the process continues. See Block 36 and loop line 38.

The sum total success effect is amplified further by a Bernoulli distribution sequence applying image quality metrics repeatedly, as needed. The outcome from a Bernoulli distribution is estimated using Equation 1 below, which is a binomial probability calculation that quantifies the effects of multiple trials, or subsequent image retries especially seeking to capture high quality iris images for both eyes at once.

$$Binomial Distribution Formula : \qquad Equation 1$$

$$P ( x : n , p ) = n ! / [ x ! ( n - x ) ! ] * {p}^{x} * {( q )}^{n - x}$$

where, n=the number of trials, or samples
x=the number of successes desired (in our case x=1)
p=probability of success in one trial
q=1−p=probability of a failure of one trial

An example starts with a low probability image with a numerical value of 58% dual-iris, singular image success rate due to the combination of many dynamic factors at play including the occasional eyelid occlusion. Using the 58% value for a single image dual-iris image capture success rate (p=0.58), the estimate for final success P(x:n,p) after seven retries exceeds 99.7%. Applying the same sequence theme in combination with more than seven frames asymptotically approaches 100% within every session for everyone. Therefore, iris quality metrics supporting a realistic full-frame rate of 18 fps, for example, virtually guarantees that ideal dual-irises will be captured in less than one second after the user positions themself into the field of view 15 for the camera assembly 12.

The iris-specific quality metrics have overlap with some of the facial quality metrics. For example, the sharpness score at the iris location of the image shares a great deal in common with the whole image. Some iris quality metrics can substitute and adequately service some facial quality metrics, therein avoiding process duplication or other optimizations such as parallel sharpness evaluation.

Counterfeit substitutes, such as a facial picture, video or mask that are designed to mimic an actual user's biometric features are a security threat to any facial biometric ID system. For a security check against counterfeits, presentation attack detection protocols are used to distinguish a counterfeit substitute from an authentic user. The fusion FAR<1E⁻²⁰ pass-threshold utilized by the identification system 10 detects inferior counterfeits, therein achieving errorless ID.

As is indicated by Block 40 and Block 41, the facial features 17 and iris patterns 18 are identified from the accepted distorted images 25. The facial features 17 and iris patterns 18 are compared to ID databases 42 to find any matches. See Block 44. The biometric check of facial features 17 and both iris patterns 18 as a counterfeit check. Given the correct index is guaranteed during ID search by iris at speeds up to one billion per second, the False Non-Match Rate (FNMR) to the face record failing to confirm is very small at 0.0001 per Face Recognition Vendor Test (FRVT). Given the correct index, then the FNMR to the other iris is <1E⁻⁶ (<0.01*0.0001). This very small error rate yields a high confidence interval (CI) that the other biometrics indeed are a correct match to themselves (>99.999% CI) and to their record (100% CI, errorless by full fusion). The inherent full-integrity of a single biometric image better realizes idempotent results with increased security that competing systems with separate images for each biometric fails to match. A single biometric image offers security enhancement potential thwarting a chain-of-custody assembly challenge as compared to a sequence of stitched-together images from multiple cameras that cannot produce an immutable process.

Dewarping the face to the exact degree is expected to happen at the server side operating in the world wide web only if it had issued an appropriate challenge and received the correct response (degree of distortion). Any attempted electronic facial image substitution likely doesn't guess the correct degree of distortion and will adversely impact the facial matching performance after dewarping. Thus, distortion is yet another PAD countermeasure feature that is powerful, secure (out-of-band) but inexpensive computationally.

Errorless identification is achieved if a match is found for the facial features 17 and both iris patterns 18. See Block 46. The same camera assembly 12 can also provide a user interface video stream further simplifying user feedback for speedy multimodal biometric image evaluation and capture of an ideal image associated to lowest FRR. Intelligent image capture of all three biometrics using a single device for errorless identification produces an ideal iris image with inherent properties with multiple benefits.

It will be understood that the embodiment of the present invention that is illustrated and described is merely exemplary and that a person skilled in the art can make many variations to that embodiment. All such embodiments are intended to be included within the scope of the present invention as defined by the appended claims.

What is claimed is:

1. A method of identifying a person using multimodal biometrics, comprising:
providing a camera assembly having a single imaging camera and an imaging lens, wherein said camera assembly produces an image having a central area and an outer area, and wherein said imaging lens produces a first level of distortion in said central area and a different second level of distortion in said outer area;
imaging a face having eyes and facial features with said camera assembly, wherein said eyes are in said central area of said image and at least some of said facial features are in said outer area of said image;
obtaining iris pattern data from said eyes imaged in said central area of said image;
obtaining facial feature data from said facial features imaged in said outer area of said image;
comparing said iris pattern data and said facial feature data to at least one identification database to identify said person.

2. The method according to claim 1, wherein said first level of distortion in said central area of said image has a first level of magnification with a first focal length.

3. The method according to claim 2, wherein said second level of distortion in said outer area of said image has a second level of magnification with a second focal length, wherein said first focal length is greater than said second focal length.

4. The method according to claim 1, wherein said outer area of said image surrounds said inner area of said image.

5. The method according to claim 1, wherein said imaging lens contains a single lens element that produces both said first area of distortion and said second level of distortion.

6. The method according to claim 1, wherein said imaging lens contains multiple lens elements that produces both said first area of distortion and said second level of distortion.

7. The method according to claim 2, wherein said second focal length is at least four percent shorter than said first focal length.

8. The method according to claim 2, wherein said first level of distortion has a magnification factor of at least four percent greater than the second level.

9. A method of identifying a person using multimodal biometrics, comprising:
providing a single imaging camera with an imaging lens that produces an image having a first area and a second area, wherein said first area is distorted with a first level of magnification;
imaging a person having facial features and iris patterns with said imaging camera, wherein said iris patterns are imaged in said first area;
obtaining iris pattern data from said iris patterns that are imaged;
comparing said iris pattern data to at least one identification database to identify said person.

10. The method according to claim 9, wherein imaging said person includes imaging at least some of said facial features in said second area of said image.

11. The method according to claim 10, further including obtaining facial feature data from said second area of said image and comparing said facial feature data to said at least one identification database to identify said person.

12. The method according to claim 11, further including identifying said person only if said iris pattern data and said facial feature data are matched in said at least one identification database.

13. The method according to claim 9, wherein said second area is distorted with a second level of magnification that is less than said first level of magnification.

14. The method according to claim 9, wherein said second area of said image surrounds said first area of said image.

15. The method according to claim 13, wherein said imaging lens contains a single lens element that produces both said first level of magnification and said second level of magnification.

16. The method according to claim 13, wherein said imaging lens contains multiple lens elements that produces both said first level of magnification and said second level of magnification.

17. The method according to claim 13, wherein said first level of magnification has a magnification factor of at least four percent greater than the second level.

18. A method of identifying a person, comprising:
providing an imaging camera with a foveal lens that produces a distorted image having a first area and a second area, wherein said first area has a greater degree of distortion than said second area;
imaging a person having facial features and iris patterns with said imaging camera, wherein said iris patterns are imaged in said first area;
obtaining iris pattern data from said iris patterns that are imaged;
comparing said iris pattern data to at least one identification database to identify said person.

19. The method according to claim 18, wherein imaging said person includes imaging at least some of said facial features in said second area of said image.

20. The method according to claim 19, further including obtaining facial feature data from said second area of said image and comparing said facial feature data to said at least one identification database to identify said person.
